(19) United States
(12) Patent Application Publication
(10) Pub. No.: US 2022/0041854 A1
(43) Pub. Date: Feb. 10, 2022

(54) EXTREMELY LOW ODOR STYRENIC POLYMER COMPOSITION

(71) Applicant: TRINSEO EUROPE GMBH, Horgen (CH)

(72) Inventor: Yao-Chu CHUNG, Hsinchu County (TW)

(21) Appl. No.: 17/417,528

(22) PCT Filed: Jul. 12, 2019
(86) PCT No.: PCT/EP2019/068843

§ 371 Date: Jun. 23, 2021

(30) Foreign Application Priority Data
Jan. 9, 2019 (EP) 19150929.8

(51) Int. Cl. C08L 55/02; C08L 25/12; C08K 5/098; C08K 3/04; C08K 3/34; C08K 3/013; C08J 3/22; C08J 3/12; B29C 48/00

(52) U.S. Cl. CPC C08L 55/02; C08L 25/12; C08K 5/098; C08K 3/04; C08K 3/34; B29C 2948/9259; C08J 3/22; C08J 3/12; B29C 48/022; C08L 2203/30; B29C 2948/92704; C08K 3/013

(57) ABSTRACT

Disclosed are vinylidene substituted aromatic polymers which include a zinc salt. Disclosed is a method of reducing the total volatile organic components in a vinylidene substituted aromatic polymer. Disclosed is a method of making vinylidene substituted aromatic polymers which include a zinc salt. Disclosed is a masterbatch which includes a styrenic polymer, a zinc salt and optionally a pigment and methods of making the masterbatch. The masterbatch may be used in a method making a styrenic polymer molded part.

### TECHNICAL FIELD

Disclosed are vinylidene substituted aromatic polymers which include a zinc salt. Disclosed is a method of reducing the total volatile organic components in a vinylidene substituted aromatic polymer. Disclosed is a method of making vinylidene substituted aromatic polymers which include a zinc salt. Disclosed is a masterbatch which includes a styrenic polymer, a zinc salt and optionally a pigment and methods of making the masterbatch. The masterbatch may be used in a method making a styrenic polymer molded part.

### BACKGROUND

Polymers prepared from vinylidene substituted aromatic monomers, such as styrene, are used in a number of polymeric systems, including foams, packaging (food packaging), medical, electronic, optical, appliance and automotive applications. Polymers of vinylidene substituted aromatic monomers do not exhibit great impact properties and modified polymers containing vinylidene substituted aromatic monomers have been developed to improve the impact resistance. Such modified polymers may contain butadiene-based rubber, for example, polymers of styrene and acrylonitrile modified with polybutadiene rubber, commonly referred to as acrylonitrile-butadiene-styrene. Such modified vinylidene substituted aromatic polymers are used in many applications such as, for example, automotive interior components.

Vinylidene substituted aromatic polymers frequently contain odorous volatile organic components, which makes use in an odor sensitive environment such as automotive interior components problematic. Thus, there is a need for vinylidene substituted aromatic polymers which have a low amount of total volatile organic components.

### SUMMARY

The vinylidene substituted aromatic polymer compositions and articles disclosed herein may include one or more zinc salts. The vinylidene substituted aromatic polymer may be a general purpose styrene (GPPS), high impact polystyrene (HIPS), styrene-acrylonitrile (SAN), acrylonitrile-butadiene-styrene (ABS) or combinations thereof. The vinylidene substituted aromatic polymers, compositions and articles disclosed may contain from about 0.05 wt % to about 2 wt % of a zinc salt. The zinc salt may be a zinc salt of a long chain acid such as, for example, zinc ricinoleate, zinc stearate, zinc palmitate, zinc laurate: zinc oxide, zinc carbonate or combinations thereof. The long chain acid may contain 20 carbons or greater or 30 carbons or greater. The long chain acid may contain 40 carbons or less.

Disclosed is a method of reducing the total volatile organic components in a vinylidene substituted aromatic polymers. The method includes the step of adding a zinc salt to the vinylidene substituted aromatic polymers. The zinc salt may be from about 0.5 wt % to about 2 wt % of the vinylidene substituted aromatic polymers.

Disclosed is a method of preparing the vinylidene substituted aromatic polymers, compositions and articles which include one or more zinc salts. The method includes the steps of mixing pellets of vinylidene substituted aromatic polymers, with a zinc salt, feeding the mixture into an extruder, collecting the extrudate and making pellets of the extrudate.

Disclosed is a masterbatch comprising: between about 70 wt % and about 90% wt % of a styrenic polymer, between about 0 wt % and 15 wt % of a pigment and between about 1 wt % and about 15 wt % of a zinc salt. Disclosed is a composition which includes between about 1 wt % and about 6 wt % of the masterbatch above and between about 94 wt % and 99 wt % of a styrenic polymer.

Disclosed is a method of making a masterbatch. The method includes the steps of mixing pellets of the styrenic polymer with a zinc salt and optionally a pigment, feeding the mixture into an extruder, collecting the extrudate and making pellets of the extrudate.

Disclosed is a method of making a styrenic polymer molding part. The method includes the steps of premixing between about 1 wt % and about 6 wt % of the masterbatch disclosed above, between about 94 wt % and 99 wt % of a styrenic polymer and feeding the mixture into an injection molding apparatus.

### DETAILED DESCRIPTION

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

One or more as used herein means that at least one, or more than one, of the recited components may be used as disclosed. Residual content of a component refers to the amount of the component present in free form or reacted with another material, such as a polymer. Typically, the residual content of a component can be calculated from the ingredients utilized to prepare the component or composition. Alternatively, it can be determined utilizing known analytical techniques. Heteroatom as used herein means nitrogen, oxygen, and sulfur, more preferred heteroatoms include nitrogen and oxygen with oxygen most preferred. Hydrocarbyl as used herein refers to a group containing one or more carbon atom backbones and hydrogen atoms, which may optionally contain one or more heteroatoms. Where the hydrocarbyl group contains heteroatoms, the heteroatoms may form one or more functional groups well known to one skilled in the art. Hydrocarbyl groups may contain cycloaliphatic, aliphatic, aromatic or any combination of such segments. The aliphatic segments can be straight or branched. The aliphatic and cycloaliphatic segments may include one or more double and/or triple bonds. Included in hydrocarbyl groups are alkyl, alkenyl, alkynyl, aryl, cycloalkyl, cycloalkenyl, alkaryl and aralkyl groups. Cycloaliphatic groups may contain both cyclic portions and noncyclic portions. Hydrocarbylene means a hydrocarbyl group or any of the described subsets having more than one valence, such as alkylene, alkenylene, alkynylene, arylene, cycloalkylene, cycloalkenylene, alkarylene and aralkylene. Valence as used herein means a covalent bond between a hydrocarbyl or hydrocarbylene group and another group such as a carbonyl, oxygen, nitrogen or sulfur containing group or atom, or the referenced base compound. As used herein percent by weight or parts by weight refer to, or are based on, the weight of the compositions unless otherwise specified.

The polymers disclosed herein contain vinylidene substituted aromatic monomers. Vinylidene substituted aromatic monomers comprise vinylidene, alkenyl groups, bonded directly to aromatic structures. The vinylidene substituted aromatic monomers may contain one or more aromatic rings, may contain one or two aromatic rings, or may contain one aromatic ring. The aromatic rings can be unsubstituted or substituted with a substituent that does not interfere with polymerization of the vinylidene substituted aromatic monomers, or the fabrication of the polymers formed into desired structures. The substituents may be halogens or alkyl groups, such as bromine, chlorine or C₁ to C₄ alkyl groups; or a methyl group. Alkenyl groups comprise straight or branched carbon chains having one or more double bonds, or one double bond. The alkenyl groups useful for the vinylidene substituted aromatic monomers may include those that when bonded to an aromatic ring are capable of polymerization to form polymers. The alkenyl groups may have 2 to 10 carbon atoms, 2 to 4 carbon atoms or 2 carbon atoms. Exemplary vinylidene substituted aromatic monomers include styrene, alpha methyl styrene, N-phenyl-maleimide and chlorinated styrenes; or alpha-methyl styrene and styrene. The vinylidene substituted aromatic monomers may be mono-vinylidene aromatic monomers, which contain one unsaturated group. Vinylidene aromatic monomers include but are not limited to those described in U.S. Pat. Nos. 4,666,987; 4,572,819 and 4,585,825, which are herein incorporated by reference. The monomer may correspond to the formula:

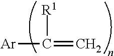

where R¹ is separately in each occurrence hydrogen or methyl and Ar is separately in each occurrence an aromatic group. Ar may contain one or more aromatic rings, may contain one or two aromatic rings, or may contain one aromatic ring. n is separately in each occurrence 1 to 3, 1 to 2 or 1. The aromatic rings can be unsubstituted or substituted with a substituent that does not interfere with polymerization of the vinylidene substituted aromatic monomers, or the fabrication of the polymers formed into desired structures. The substituents may be halogens or alkyl groups, such as bromine, chlorine or C₁ to C₄ alkyl groups; or a methyl group. The vinylidene substituted aromatic monomers may be present in the polymers in a sufficient amount such that the polymer exhibits the advantageous properties associated with polymers of vinylidene substituted aromatic monomers, for instance polystyrene. Among the advantageous properties of polymers of vinylidene substituted monomers include glass transition temperatures of about 100° C. or greater, transparency where desired for the use, high heat deflection temperatures, and the like. Other advantageous properties of polymers of vinylidene substituted monomers include processability, stiffness, and thermal stability. The polymers disclosed herein contain vinylidene substituted aromatic monomers in an amount of about 10 percent by weight of the polymers or greater, about 15 percent by weight or greater or about 20 percent by weight or greater. The polymers of one or more vinylidene aromatic monomers and one or more unsaturated compounds containing a nucleophilic group may contain vinylidene substituted aromatic monomers in an amount of about 85 percent by weight of the polymers or greater, about 90 percent by weight or greater or about 95 percent by weight or greater.

The compositions may contain branching agents commonly used in vinylidene aromatic based polymers. The branching agents may be vinylidene substituted aromatic monomers having 2 or more vinylidene groups. Other branching agents may include other difunctional and in general multifunctional (functionality>2) monomers, multifunctional initiators and multifunctional chain transfer agents and the like. The branching agents may be present in the polymerizable compositions in an amount of about 0.001 percent by weight of the composition or greater, about 0.002 percent by weight or greater or about 0.003 percent by weight or greater. The branching agents may be present in the polymerizable compositions in an amount of about 0.5 percent by weight of the composition or less, about 0.2 percent by weight or less or about 0.1 percent by weight or less.

The polymers disclosed herein may further comprise one or more (meth)acrylates. (Meth) acrylate as used herein refers to compounds having a vinyl group bonded to the carbonyl moiety of an alkyl ester wherein the carbon of the vinyl group bonded to the carbonyl group further has a hydrogen or a methyl group bonded thereto. The term (meth) as used in this context refers to compounds having either of a hydrogen or methyl group on the carbon of the vinyl group bonded to the carbonyl group. (Meth)acrylates useful include those that correspond to the formula:

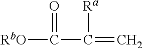

wherein R^{a} is separately in each occurrence H or —CH₃; and R^{b} may be a C₁ to C-₃₀ alkyl group or C₁₋₁₀ alkyl group. Examples of the one or more (meth)acrylates include lower alkyl (meth)acrylates, such as methyl (meth)acrylate, ethyl (meth)acrylate, propyl (meth)acrylate, butyl (meth)acrylate, pentyl (meth)(acrylate) and hexyl (meth) acrylate. The one or more (meth)acrylates in the polymer may be present in sufficient amount to provide the desired properties of the polymer such as processability, practical toughness, refractive index, environmental stress crack resistance, hydrolytic stability, thermal stability, UV stability, impact resistance, weatherability, and the like. The polymers disclosed herein contain (meth)acrylates in an amount of about 0 percent by weight of the polymerizable compositions or polymers or greater, about 1 percent by weight or greater or about 2 percent by weight or greater. The polymers disclosed herein contain (meth)acrylates in an amount of about 20 percent by weight of the polymerizable compositions or polymers or less, about 15 percent by weight or less, about 10 percent by weight or less, about 8 percent by weight or less or about 5 percent by weight or less.

The polymers may further comprise one or more unsaturated nitriles. Unsaturated nitriles include, but are not limited to, acrylonitrile, methacrylonitrile, ethacrylonitrile, fumaronitrile and mixtures thereof. The unsaturated nitrile may be acrylonitrile. The unsaturated nitriles are used in the polymers to enhance the glass transition temperature, transparency, chemical resistance and the like. The polymers disclosed herein may contain one or more unsaturated nitriles in an amount of about 0 percent by weight of the polymers or greater, about 1 percent by weight or greater or about 2 percent by weight or greater. The polymers may contain one or more unsaturated nitriles in an amount of about 40 percent by weight of the polymers or less, about 35 percent by weight or less, about 30 percent by weight or less or about 20 percent by weight or less.

Other vinyl monomers may also be included in the polymers, in sufficient amount to provide the desired properties as disclosed herein, including conjugated 1,3 dienes (for example butadiene, isoprene, etc.); alpha- or beta-unsaturated monobasic acids and derivatives thereof (for example, acrylic acid, methacrylic acid, etc.); vinyl halides such as vinyl chloride, vinyl bromide; vinylidene chloride, vinylidene bromide; vinyl esters such as vinyl acetate, vinyl propionate, etc.; ethylenically unsaturated dicarboxylic acids and anhydrides and derivatives thereof, such as maleic acid, fumaric acid, maleic anhydride, dialkyl maleates or fumarates, such as dimethyl maleate, diethyl maleate, dibutyl maleate, the corresponding fumarates, N-phenyl maleimide (N-PMI); and the like. These additional comonomers can be incorporated in to the composition in several ways including, interpolymerization with the vinylidene substituted aromatic containing copolymer and/or polymerization into polymeric components which can be combined, for example blended with the polymer. If present, the amount of such comonomers may be equal to or less than about 20 weight percent, equal to or less than about 10 weight percent or equal to about 5 weight percent based on the total weight of the polymeric composition. Such comonomers may be present in an amount of about 1 percent by weight or greater.

The compositions disclosed may contain impact modifiers. The terms impact modifiers and rubbers are used interchangeably herein. Various impact modifiers may be used in the compositions disclosed; such as diene rubbers, ethylene propylene rubbers, ethylene propylene diene (EPDM) rubbers, ethylene copolymer rubbers, acrylate rubbers, polyisoprene rubbers, silicon rubbers, silicon-acrylate rubbers, polyurethanes, thermoplastic elastomers, halogen containing rubbers, and mixtures thereof. Also suitable are inter-polymers of rubber-forming monomers with other copolymerizable monomers. The rubbers may be present in the formulated composition in sufficient amount to provide the desired impact properties to the composition. Desired impact properties include increased izod, charpy, gardner, tensile, falling dart, and the like. The compositions disclosed herein may contain impact modifiers (rubbers) in an amount of about 0.5 percent by weight of the compositions or greater, about 1 percent by weight or greater, about 2 percent by weight or greater or about 7 percent by weight or greater. The compositions disclosed herein may contain impact modifiers (rubbers) in an amount of about 50 percent by weight of the compositions or less, about 45 percent by weight or less, about 40 percent by weight or less, about 30 percent by weight or less, about 20 percent by weight or less or about 10 percent by weight or less. The compositions disclosed herein may contain the copolymer in an amount of about 0.5 percent by weight of the compositions or greater. The compositions disclosed herein contain copolymer in an amount of about 99.5 percent by weight of the compositions or less, 93 percent by weight of the compositions or less, 80 percent by weight of the compositions or less or 50 percent by weight of the compositions or less. Compositions, formulated compositions, as used in this context are the formulated compositions containing all of the ingredients for the intended use.

The rubbers may be diene rubbers such as polybutadiene, polyisoprene, polypiperylene, polychloroprene, and the like or mixtures of diene rubbers, that is, any rubbery polymers of one or more conjugated 1,3-dienes, such as 1,3-butadiene. Such rubbers include homopolymers of 1,3-butadiene and polymers of 1,3-butadiene with one or more copolymerizable monomers, such as vinylidene substituted aromatic (styrene). The diene rubber may be the homopolymer of 1,3-butadiene. Exemplary polymers of 1,3-butadiene are block or tapered block rubbers of at least about 30 weight percent 1,3-butadiene, from about 50 weight percent, from about 70 weight percent, or from about 90 weight percent 1,3-butadiene and up to about 70 weight percent vinylidene substituted aromatic monomer, up to about 50 weight percent, up to about 30 weight percent, or up to about 10 weight percent vinylidene substituted aromatic monomer, weights based on the weight of the 1,3-butadiene copolymer.

The impact modifiers employed may be those polymers and polymers which exhibit a second order transition temperature, sometimes referred to as the glass transition temperature (Tg), for the diene fragment which is not higher than 0° C. or not higher than −20° C. as determined using conventional techniques, for example ASTM Test Method D 746-52 T. Tg is the temperature or temperature range at which a polymeric material shows an abrupt change in its physical properties, including, for example, mechanical strength. Tg can be determined by differential scanning calorimetry (DSC). The diene rubber may have a weight average molecular weight of at least about 100 kilograms per mole (kg/mole) or a weight average molecular weight of at least about a 300 kg/mole. The diene rubber may have a weight-average molecular weight equal to or less than about 900 kg/mole or a weight average molecular weight equal to or less than 600 kg/mole. The diene rubber having a solution viscosity of at least 10 centiStokes (cSt) (10 percent (%) solution in styrene) or a solution viscosity of about 30 cSt. The diene rubber may have a solution viscosity equal to or less than about 500 cSt or equal to or less than about 400 cSt. The rubber, with graft and/or occluded polymers if present, is dispersed in the continuous matrix phase as discrete particles.

The rubber particles may comprise a range of sizes having a mono-modal, bimodal, or multimodal distribution. The average particle size of a rubber particle, as used herein, will, refer to the volume average diameter. In most cases, the volume average diameter of a group of particles is the same as the weight average. The average particle diameter measurement generally includes the polymer grafted to the rubber particles and occlusions of polymer within the particles. Unless otherwise specified, the rubber particle sizes disclosed and claimed herein are determined on a Coulter Multisizer II or II e with the ACCUCOMPTM Software Version 2.01 by the following method: about 3 granules of polymer samples (30-70 mg) are dissolved in 5 milliliters (ml) of Dimethyl Formamide (DMF), using an ultrasonic bath for agitation for approximately 15 to 20 minutes. 10 ml or an electrolyte solution (1 percent of NELSON in DMF) is mixed with 0.2 ml of the sample solution. The coulter measuring stand is used with 20 micrometer Coulter tube and a 1.16 micrometer calibration material. The coincidence level indicator of the apparatus should read between 5 and 10 percent. If the reading is above 10 percent, dilute the sample in a beaker with electrolyte solution, or if it is too low, add more drops of the polymer solution in DMF. The volumetric mean particle size is reported. The average particle size of the rubber particles may be equal to or greater than about 0.05 micrometers (microns) (μm), equal to or greater than about 0.1 micrometers, and about 0.6 micrometers. The average particle size of the rubber particles may be equal to or less than about 10 micrometers, equal to or less than about 5 micrometers, or equal to or less than about 2 micrometers.

The disclosed compositions may also optionally contain one or more additives that are commonly used in compositions of this type. Exemplary additives include: ignition resistant additives, stabilizers, colorants (e.g., pigments, carbon black, TiO₂, etc.), antioxidants (e.g., IRGANOX 1076 or IRGAFOS 178), adsorbers (e.g., zeolites, activated carbon, bamboo charcoal, etc.) antistats, silicon oils, flow enhancers, mold releases, etc. Exemplary ignition resistance additives include halogenated hydrocarbons, halogenated carbonate oligomers, halogenated diglycidyl ethers, organophosphorous compounds, fluorinated olefins, antimony oxide and metal salts of aromatic sulfur, or a mixture thereof may be used. Compounds which stabilize mass polymerized rubber-modified vinylidene substituted aromatic copolymer compositions against degradation caused by, but not limited to heat, light, and oxygen, or a mixture thereof may be used. Fillers and reinforcements may also be present. Exemplary fillers include talc, clay, wollastonite, mica, glass or a mixture thereof. Some of these additives may adsorb volatile organic compounds, such as, for example, zeolites, activated carbon, bamboo charcoal, etc.

If used, such additives and/or fillers and/or adsorbents may be present in the formulated compositions in an amount about 0.01 percent by weight or greater, about 0.1 percent by weight or greater, about 1 percent by weight or greater, about 2 percent by weight or greater, or about 3 percent by weight or greater based on the weight of the compositions. The additives and/or fillers may be present in an amount of about 40 percent by weight or less, about 30 percent by weight or less, about 20 percent by weight or less, about 15 percent by weight or less, about 10 percent by weight or less, about 5 percent by weight or less based on the weight of the composition. The additives and adsorbents may be independently present in amounts up to 5 weight percent while fillers may be present in amounts up to 40 weight percent based on the weight of the compositions.

Also disclosed herein are exemplary vinylidene substituted aromatic copolymers including acrylonitrile and styrene monomers in various proportions. The acrylonitrile-styrene polymers disclosed may contain styrene monomer in a concentration of about 25 percent by weight or more, about 50 percent by weight or more, or about 70 percent by weight or more and acrylonitrile monomer in a concentration of about 25 percent by weight or more, or about 50 percent by weight or more or more or about 70 percent by weight or more. The acrylonitrile-styrene polymers disclosed may contain styrene monomer at a concentration of, about 80 percent by weight or less, about 55 percent by weight or less or about 30 percent by weight or less and acrylonitrile monomer at a concentration of about 80 percent by weight or less, about 55 percent by weight or less, or less or about 30 percent by weight or less.

Also disclosed herein are exemplary vinylidene substituted aromatic polymers comprised of a nitrile monomer, a diene monomer and a vinylidene substituted aromatic monomer in various proportions, which may result in drastically different physical properties. The polymers disclosed may contain vinylidene substituted aromatic monomer in a concentration of about 50 percent by weight or more, about 65 percent by weight or more, about 70 percent by weight or more, diene monomer in a concentration of about 6 percent by weight or more, about 9 percent by weight or more, about 12 percent by weight or more, about 15 percent by weight or more, nitrile monomer in a concentration of about 10 percent by weight or more, about 20 percent by weight or more, about 30 percent by weight or more. The polymers disclosed may contain vinylidene substituted aromatic monomer at a concentration of about 55 percent by weight or less, about 60 percent by weight or less or about 75 percent by weight or less, diene monomer at a concentration of about 8 percent by weight or less, about 13 percent by weight or less or about 18 percent by weight or less, nitrile monomer at a concentration of about 15 percent by weight or less, about 25 percent by weight or less, about 35 percent by weight or less. The polymers disclosed may contain vinylidene substituted aromatic monomer at a concentration of about 60 percent by weight, diene monomer at a concentration of about 12 percent by weight or less and nitrile monomer at a concentration of about 23 percent.

Also disclosed herein are exemplary vinylidene substituted aromatic polymers including acrylonitrile, butadiene and styrene monomers in various proportions. The acrylonitrile-butadiene-styrene polymers disclosed may contain styrene monomer in a concentration of about 50 percent by weight or more, about 65 percent by weight or more, about 70 percent by weight or more, butadiene monomer in a concentration of about 6 percent by weight or more, about 9 percent by weight or more, about 12 percent by weight or more, about 15 percent by weight or more, acrylonitrile monomer in a concentration of about 10 percent by weight or more, about 20 percent by weight or more, about 30 percent by weight or more. The acrylonitrile-butadiene-styrene polymers disclosed may contain styrene monomer at a concentration of about 55 percent by weight or less, about 60 percent by weight or less or about 75 percent by weight or less, butadiene monomer at a concentration of about 8 percent by weight or less, about 13 percent by weight or less or about 18 percent by weight or less, acrylonitrile monomer at a concentration of about 15 percent by weight or less, about 25 percent by weight or less, about 35 percent by weight or less. The acrylonitrile-butadiene-styrene polymers disclosed may contain styrene monomer at a concentration of about 60 percent by weight, butadiene monomer at a concentration of about 12 percent by weight or less and acrylonitrile monomer at a concentration of about 23 percent. The acrylonitrile-butadiene-styrene polymers disclosed may be analyzed by several different methods including, for example, FTIR (i.e., Fourier transform infrared spectroscopy), which may be used characterize peaks of functional groups of acrylonitrile, styrene, and butadiene rubber, PGC-MS (i.e., pyrolysis gas chromatography-mass spectroscopy) and EG-MS (i.e., thermal evolved gas analyzer-mass spectroscopy).

The polymers disclosed may optionally include acrylate comonomer and/or maleimide comonomer. The comonomer may be n-butyl acrylate or N-phenyl maleimide or combinations thereof. The n-butyl acrylate may be present in an amount of less than about 10 wt %, while the N-phenyl maleimide may be present in an amount of less than about 5 wt %.

The polymers disclosed herein include a zinc salt. The polymers, compositions and articles disclosed may contain from about 0.05 wt % to about 2 wt % of a zinc salt. The polymer may be general purpose styrene (GPPS), high impact polystyrene (HIPS), styrene-acrylonitrile (SAN), acrylonitrile-butadiene-styrene (ABS) or combinations thereof.

The zinc salt may be a zinc salt of a long chain fatty acid such as, for example, zinc ricinoleate, zinc stearate, zinc palmitate, zinc laurate: zinc oxide, zinc carbonate or combinations thereof. The long chain acid may contain 20 carbons or greater or 30 carbons or greater. The long chain acid may contain 40 carbons or less. The zinc salt may be zinc ricinoleate, zinc stearate, zinc palmitate, zinc laurate, zinc oxide, zinc carbonate or combinations thereof.

The polymer may optionally include a component which adsorbs volatile organic compounds. The component may be a zeolite, activated carbon, bamboo, charcoal or combinations thereof. The polymer may also include antioxidants, stearate salts, colorants, mold release agents or combinations thereof.

The amount of residual styrene in the polymers may be between about 50 ppm and about 300 ppm, between about 100 ppm and about 200 ppm, between about 125 ppm and about 175 ppm or between about 140 ppm and about 160 ppm.

Also disclosed is an acrylonitrile-butadiene-styrene polymer which includes a zinc salt. The acrylonitrile-butadiene-styrene polymers, compositions and articles disclosed may contain from about 0.05 wt % to about 2 wt % of a zinc salt. The zinc salt may be a zinc salt of a long chain fatty acid such as, for example, zinc ricinoleate, zinc stearate, zinc palmitate, zinc laurate: zinc oxide, zinc carbonate or combinations thereof. The long chain acid may contain 20 carbons or greater or 30 carbons or greater. The long chain acid may contain 40 carbons or less. The zinc salt may be zinc ricinoleate, zinc stearate, zinc palmitate, zinc laurate, zinc oxide, zinc carbonate or combinations thereof.

The concentration of acrylonitrile may be between about 5 wt % and about 40 wt %, the concentration of butadiene may be between about 5 wt % and about 35 t % and the concentration of styrene may be between about 25 wt % and about 90 wt % in the acrylonitrile-butadiene-styrene polymer The concentration of acrylonitrile may be between about 10 wt % and about 30 wt %, the concentration of butadiene may be between about 6 wt % and about 18 wt % and the concentration of styrene may be between about 50 wt % and about 75 wt % in the acrylonitrile-butadiene-styrene polymer. The concentration of acrylonitrile may be between about 18 wt % and about 23 wt %, the concentration of butadiene may be between about 9 wt % and the concentration of styrene may be between 55 wt % and about 65 wt % in the acrylonitrile-butadiene-styrene polymer. The concentration of acrylonitrile may be about 23 wt % the concentration of butadiene may be about 12 wt % and the concentration of styrene may be about 60 wt % in the acrylonitrile-butadiene-styrene polymer.

The vinylidene substituted aromatic polymers disclosed may contain one or more zinc salts in a concentration sufficient to reduce the amount of volatile organic compounds in the polymers. The vinylidene substituted aromatic polymers disclosed may contain one or more zinc salts in a concentration of about 0.05 percent by weight or more, about 0.1 percent by weight or more, about 0.5 percent by weight or more or about 1 percent by weight or more. The vinylidene substituted aromatic polymers disclosed may contain a zinc salt at a concentration of about 4 percent by weight or less, about 3 percent by weight or less or about 2 percent by weight or less or 1.5 percent by weight or less. The zinc salt may be zinc ricinoleate and the polymer may be an acrylonitrile-butadiene-styrene copolymer, which may optionally include n-butyl acrylate and/or N-phenyl maleimide.

The polymers disclosed herein are may contain may contain volatile organic components at an amount of less than about 100 μg/g, less than about 50 μg/g, less than about 30 μg/g, less than about 20 μg/g or less than about 10 μg/g. The polymers disclosed herein are may contain may contain volatile organic components at an amount of greater than about 75 μg/g, greater than about 25 μg/g, greater than about 15 μg/g, or greater than about 10 μg/g. The volatile organic compounds may be measured by the methods described in the Examples. The polymer may be an acrylonitrile-butadiene-styrene copolymer.

The polymers disclosed herein are may contain may contain the vinylidene substituted aromatic monomer at an amount of less than about 300 ppm, less than about 200 ppm, less than about 175 ppm or less than about 160 ppm. The polymers disclosed herein are may contain may contain the vinylidene substituted aromatic monomer at an amount of greater than about 50 ppm, greater than about 100 ppm, greater than about 125 ppm or greater than about 140 ppm. The polymer may be an acrylonitrile-butadiene-styrene copolymer.

Also disclosed is a master batch which may be used to prepare styrenic polymers which includes from about 0.05 wt % to about 2.0 wt % of a zinc salt. The masterbatch includes between about 70 wt % and about 90 wt % of a styrenic polymer, between about 0 wt % and 15 wt % of a pigment and between about 1 wt % and about 15 wt % of a zinc salt. The masterbatch may include between about 85 wt % and about 95 wt % of a styrenic polymer, between about 3 wt % and 10 wt % of a pigment and between about 1.5 wt % and about 10 wt % of a zinc salt. The masterbatch may include between about 87 wt % and about 93 wt % of a styrenic polymer, between about 4 wt % and 6 wt % of a pigment and between about 2.5 wt % and about 7.5 wt % of a zinc salt.

The zinc salt in the masterbatch may be the salt of a fatty acid, zinc oxide, zinc carbonate or combinations thereof. The zinc salt may be zinc ricinoleate, zinc stearate, zinc palmitate, zinc laurate, zinc oxide, zinc carbonate or combinations thereof.

The masterbatch may further include a component which adsorbs volatile organic compound, such as for example, a zeolite, activated carbon, bamboo charcoal or combinations thereof. The master batch may also optionally include antioxidants (between about 0.5 wt % and about 1 wt % such as, for example, IRGANOX 1076 or IRGANFOS 168 or combinations thereof), stearate salts (between about 0.5 wt % and about 2 wt % of salts such as, for example, Zn stearate), colorants (between about 0.5 wt % and about 3 wt % of colorants such as, for example, organic dyes, TiO₂, inorganic pigments or combinations thereof) mold release agents (between about 0.5 wt % and about 4 wt % of agents such as, for example, stearic acid, ethylene bis(stearamide) stearamide, oleamide or erucamide or combinations thereof) or combinations thereof.

Various techniques for producing the polymers are disclosed. Examples of these known polymerization processes include bulk, mass-solution, or mass-suspension polymerization, generally known as mass polymerization processes. For a good discussion of how to make monovinylidene aromatic copolymer containing compositions see “Modern Styrenic Polymers” of Series In Polymer Science (Wiley), Ed. John Scheirs and Duane Priddy, ISBN 0 471 497525. Also, for example, U.S. Pat. Nos. 3,660,535; 3,243,481; and 4,239,863. Continuous mass polymerization techniques are advantageously employed in preparing the polymers. The polymerization may conducted in one or more substantially linear, stratified flow or so-called “plug-flow” type reactors such as described in U.S. Pat. No. 2,727,884, sometimes referred to as multizone plug flow bulk process, which may or may not comprise recirculation of a portion of the partially polymerized product or, alternatively, in a stirred tank reactor wherein the contents of the reactor are essentially uniform throughout, which is generally employed in combination with one or more plug-flow type reactors. The stirred tank reactors can be boiling and/or coil reactors. Such reactors can be used in series. Processes for use of the stirred tank reactors for preparing polymers are disclosed in Modern Styrenic Polymers, Edited by John Schiers and Duane Priddy, Wiley, ISBN 0 471 49752 5, published in 2003, see pp 43-72, relevant portions incorporated herein by reference. Alternatively, a parallel reactor set-up, as taught in EP 412801, may also be suitable for preparing the polymers.

Multizone plug flow bulk processes include a series of polymerization vessels (or towers), consecutively connected to each other, providing multiple reaction zones. A mixture of monomers used to prepare the copolymer is formed and then fed into the reaction system. A rubber, for example butadiene rubber may be dissolved in the mixture monomers before being fed into the reaction system. The polymerization can be thermally or chemically initiated, and viscosity of the reaction mixture will gradually increase. During the reaction course, where present, the rubber may become grafted with the copolymer and, in the rubber solution, bulk copolymer (referred to also as free copolymer or matrix copolymer or non-grafted copolymer) is also formed. At a point where the free copolymer cannot be “held” in one single, continuous “phase” of rubber solution, it begins to form domains of copolymer dissolved in monomer and solvent. The polymerization mixture now is a two-phase system. As polymerization proceeds, more and more free copolymer is formed, and the rubber phase starts to disperse itself (rubber domains) in the matrix of the ever-growing free copolymer phase. Eventually, the free copolymer becomes a continuous phase. Some copolymer is occluded inside the rubber particles as well. Pre-phase inversion means that the rubber solution is a continuous phase and that no rubber particles are formed, and post phase inversion means that substantially all the rubber phase has converted to rubber domains and there is a continuous copolymer phase. Following the phase inversion, more matrix copolymer may be formed.

A feed with a functional monomer such as N-phenyl maleimide that increases the Tg of the matrix and also the heat resistance of the product can be added in one or more location throughout the polymerization process, the location(s) may be the same or different from where the co-monomers are added, for example, see U.S. Pat. Nos. 5,412,036 and 5,446,103.

A feed with a functional additive such as ethylene-bisstearamide, dialkyladipates, polydimethylsiloxane, or other lubricants or release agents that increases the processability of the product can be added in one or more location throughout the polymerization, devolatization and conveying process, the location(s) may be the same or different from where the co-monomers are added.

When a desirable monomer conversion level and a matrix copolymer of desired molecular weight distribution is obtained, where rubber is present, the polymerization mixture may then be subjected to conditions sufficient to cross-link the rubber and remove any unreacted monomer and solvent. Such cross-linking and removal of unreacted monomer, as well as removal of diluent or solvent, if employed, and other volatile materials is advantageously conducted employing conventional devolatilization techniques, such as introducing the polymerization mixture into a devolatilizing chamber, flashing off the monomer and other volatiles at elevated temperatures, for example, from 130° C. to 300° C. and/or under vacuum and removing them from the chamber. Thereafter the polymer may be extruded, and bulk pellets obtained from a pelletizer.

The temperatures at which polymerization is conducted are dependent on a variety of factors including the specific initiator and type and concentration of rubber, comonomers, reactor set-up (for example, linear, parallel, recirculation, etc.), and reaction solvent, if any, employed. Polymerization temperatures from about 60° C. to about 160° C. may be employed prior to phase inversion with temperatures from about 100° C. to about 200° C. being employed subsequent to phase inversion. Mass polymerization at such elevated temperatures is continued until the desired conversion of monomers to polymer is obtained. Generally, conversion (also sometimes referred to as percent solids) of from 55 to 90, or 60 to 85, weight percent of the monomers added to the polymerization system (that is, monomers added in the feed and any additional stream, including any recycle stream) to polymer is desired. Percent solids is the ratio of the weight of the solids (for example, rubber plus matrix (co)polymer) to the weight of the reaction mixture (for example, unpolymerized monomer(s)) expressed in percent at any specified time during the polymerization reaction.

To synthesize rubber-modified polymers with high performance by the mass process, four aspects are important among many others. These aspects are grafting of the rubber substrate prior to phase inversion, rubbery domain and/or particle formation or sizing during phase inversion, building molecular weight and molecular weight distribution of the matrix, and cross-linking of the rubber particle at the completion point of the mass polymerization. Alternatively, a combination of mass and suspension polymerization techniques are employed. Using these techniques, following phase inversion and subsequent size stabilization of the rubber particles, the partially polymerized product can be suspended with or without additional monomers in an aqueous medium which contains a polymerized initiator and polymerization subsequently completed. The rubber-modified copolymer is subsequently separated from the aqueous medium by acidification, centrifugation or filtration. The recovered product is then washed with water and dried.

A polymer's molecular weight is directly related to the entanglement effects contributing to its rheological and physical properties. The molecular weight of the matrix copolymer produced in the grafting reactor during the production of the rubber-modified vinylidene aromatic substituted copolymer can be adjusted by the addition of a suitable chain transfer agent. Chain transfer agents, or molecular weight regulators, are substances which can undergo atom or group transfer or an addition-elimination. Organic molecules with labile hydrogens and are well known, for example, alpha-methyl styrene dimer, mercaptans or thiols such as n-dodecylmercaptan (nDM) and thioglycolate, disulfides, dithiauram disulfides, monosulfides, halides or halocarbons, common solvents and certain unsaturated compounds such as allyl peroxides, allyl halides, allyl sulfides, and terpenes such as terpinoline. Also transition metal complexes as cobalt(II) porphyrin complexes can be used as transfer agent. Chain transfer agents are added in an amount from about 0.0001 to 10 weight percent based on the weight of the reaction mixture (that is, rubber, monomer(s), and solvent, if any). The chain transfer agent may be added in an amount equal to or greater than about 0.001 weight percent, about 0.002, or about 0.003 weight percent based on the weight of the reaction mixture. The chain transfer agent may be added in an amount equal to or less than about 0.5 weight percent, about 0.2, or about 0.1 weight percent based on the weight of the reaction mixture.

The chain transfer agent may be added all at once in one reactor zone or it may be added in two or more reactor zones. Chain transfer agent may be added before phase inversion, during rubber particle sizing, more may be added after particle sizing to help control the matrix molecular weight, and optionally more may be added later to fine tune the matrix molecular weight/molecular weight distribution. The chain transfer agent may be added at the beginning of the polymerization (in other words, at a time where the percent solids for the reaction mixture is equal to the weight percent rubber) in a first amount equal to or greater than 0.001 weight percent, from about 0.002 and about 0.1 weight percent, or from about 0.003 and about 0.05 weight percent based on the weight of the reaction mixture. The amount of chain transfer agent added later, for example after about 40 percent solids, 30 percent solids, is added in a second amount equal to or less than about 0.7 weight percent, about 0.001 to about 0.6 weight percent, or from about 0.002 to about 0.5 weight percent based on the weight of the reaction mixture. The molecular weight of the matrix copolymer depends on, among other things, how much chain transfer agent is used and when it is added.

Also disclosed herein is method of reducing the amount of volatile organic compounds in vinylidene substituted aromatic polymers described herein. The method includes the step of adding from about 0.05 wt % to about 2.0 wt % of a zinc salt to the vinylidene substituted aromatic copolymer. The vinylidene substituted aromatic polymer may be an acrylonitrile-butadiene-styrene copolymer.

Also disclosed is method of preparing of a vinylidene substituted aromatic polymer, which includes from about 0.05 wt % to about 2.0 wt % of a zinc salt. The method includes the step of mixing pellets of vinylidene substituted aromatic copolymer with a zinc salt and optionally, an adsorbent from about 0% to about 5%, feeding the mixture into an extruder, which may be an intermeshing co-rotating twin screw extruder, collecting the extrudate and making pellets of the extrudate. The barrel of the extruder may be from about 210° C. to about 240° C. and the rate of screw rotation may be from about 250 rpm to about 350 rpm. The vinylidene substituted aromatic polymer may be an acrylonitrile-butadiene-styrene copolymer.

Also disclosed is a method of making a masterbatch which may be used to prepare styrenic polymers which includes from between about 70 wt % and about 90% wt % of a styrenic polymer between about 0.05 wt % to about 2.0 wt % of a zinc salt and between about 0 wt % and 15 wt % of a pigment. The method includes the steps of mixing pellets of a styrenic polymer with a zinc salt and optionally a pigment, feeding the mixture into an extruder, collecting the extrudate; and making pellets of the extrudate.

Also disclosed is a method of making a styrenic polymer molding part. The method includes the steps premixing between about 1 wt % and about 6 wt % of the masterbatch which includes from between about 70 wt % and about 90% wt % of a styrenic polymer between about 0.05 wt % to about 2.0 wt % of a zinc salt and between about 0 wt % and 15 wt % of a pigment with between about 94 wt % and 99 wt % of a styrenic polymer; and feeding the mixture into an injection molding apparatus.

Disclosed are articles prepared from the compositions disclosed herein. Such articles may be fabricated in any known manner commonly used with polymers containing one or more vinylidene substituted aromatic compounds. The articles may be fabricated by molding, extrusion, thermoforming, foaming, blow molding, injection molding, extrusion blow molding and combinations thereof. The articles may be molded, extruded, extruded and molded, and the like. The articles disclosed may exhibit glass transition temperatures of about 100° C. or greater. The articles disclosed may be transparent or opaque.

All patent and literature references disclosed herein are incorporated in their entirety for all purposes.

### ILLUSTRATIVE EXAMPLES

The following examples are provided to illustrate the invention but are not intended to limit the scope thereof. All parts and percentages are by weight unless otherwise indicated.

### Example 1

### Preparation of Mass Produced Acrylonitrile-Butadiene-Styrene Copolymer

The copolymer is prepared using the procedure described in Shields et al., International Publication No. WO2007047120A2). The resin for samples 1 to 6, infra, are mass produced acrylonitrile butadiene styrene terpolymer resins where 10.2 weight percent rubber is dissolved in 53.3 weight percent styrene, 17.5 weight percent acrylonitrile, 19 weight percent ethylbenzene, and optionally N-phenyl maleimide to form a reaction feed stream. The mixture is polymerized in continuous process with agitation. The polymerization occurs in a multi-staged reactor system with an increasing temperature profile. During the polymerization process, some of the copolymer grafts to the rubber molecules while some forms the matrix copolymer.

A continuous polymerization apparatus composed of four plug flow reactors connected in series, wherein each plug flow reactor is divided in three zones of equal size, each zone having a separate temperature control and equipped with an agitator, is continuously charged in zone I with a feed of 17.8 g/hr composed of a rubber component, styrene, acrylonitrile, and ethyl benzene, at such a rate that the total residence time in the apparatus is approximately 7 hours. 1,1-di(t-butyl peroxy) cyclohexane is added to the feed line to the first reactor, n-dodecylmercaptan (nDM) (chain transfer agent) is added to different zones to optimize the rubber particle sizing and the matrix molecular weight. After passing through the four reactors, the polymerization mixture is guided to a separation and monomer recovery step using a preheater followed by a devolatilizer. The molten resin is stranded and cut in granular pellets. The monomers and ethyl benzene are recycled and fed to the polymerization apparatus.

Temperatures for (a) the four reactors are: reactor 1: (Zone 1, 108° C.), (Zone 2, 110° C.), and (Zone 3, 114° C.); reactor 2: (Zone 4, 117° C.), (Zone 5, 119° C.), and (Zone 6 121° C.); reactor 3: (Zone 7, 124° C.), (Zone 8, 131° C.), and (Zone 9, 141° C.), and reactor 4:(Zone 10, 152° C.), (Zone 11, 162° C.), and (Zone 12, 173° C.). Agitation is set for each of the reactors at 100, 1 10, 50, and 10 revolutions per minute (RPM) for reactors 1 to 4, respectively. Samples are tested at the end of each reactor to determine percent conversion and are expressed as percent solids based on the weight of the reaction mixture. The pellets of copolymer are used to prepare low odor formulation by twin-screw compounding process.

### Example 2

### Preparation of Mass Produced Acrylonitrile-Butadiene-Styrene Copolymer Compounded with Zinc Ricinoleate

The pellets of acrylonitrile butadiene styrene prepared in Example 1 are dry mixed with zinc ricinoleate in a mixer. The dry blended mixture is fed to a 40 mm CPM CX 40 fully intermeshing co-rotating twin screw extruder. The following are the compounding conditions in the extruder: Barrel temperature profile: 210° C., 220° C., 220° C., 230° C., and 240° C. and screw speed of 300 rotations per minute (RPM). The extrudate strand is cooled in water bath and then pellets are formed. The pellet product is analyzed by VDA-277 and VDA-270 described in Examples 3 and 4, respectively.

### Example 3

### The Preparation of a Representative Masterbatch

The masterbatches are prepared by pre-mixing SAN powder, carbon black, and zinc ricinoleate in a mixer. The dry blended mixture is feed to a 40 mm CPM CX 40 fully intermeshing co-rotating twin screw extruder. The following are the compounding conditions in the extruder: barrel temperature profile: 170° C., 180° C., 190° C., 190° C., and 190° C. and screw speed of 350 rotations per minute (RPM). The extrudate strand is cooled in water bath and is then pelletized. The composition of the masterbatches is shown in the table below:

| Masterbatch | MB1 | MB2 | MB3 |
|---|---|---|---|
| Grounded powder | 95 | 92.5 | 87.5 |
| of SAN | | | |
| Carbon black | 5 | 5 | 5 |
| Zinc ricinoleate, | | 2.5 | 7.5 |

### Example 4

### Injection Molding of an ABS Part

An ABS pellet and a masterbatch pellet made as described in Example 3 are premixed in a tumbler mixer. The pellets are dried in an air draft oven for 4 hours at 80° C. and then are used to prepare test specimens on a 110 ton CREATOR CI-110 injection molding machine, having the following molding conditions: barrel temperature of 260° C., nozzle temperature of 250° C., mold temperature of 50° C., injection time: 3 seconds, holding time 9 second, cooling time 20 seconds.

| | Comp. Example | Example | |
|---|---|---|---|
| Composition | 1 | 2 | 3 |
| ABS Trinseo | 96 | 96 | 96 |
| MAGNUM ™ 3416sc | | | |
| MB1 | 4 | | |
| MB2 | | 4 | |
| MB3 | | | 4 |
| Final concentration of | 0 | 0.1 | 0.3 |
| zinc ricinoleate (wt %) | | | |

### Example 5

### Testing of Mass Produced Acrylonitrile-Butadiene-Styrene Copolymer Compounded with Zinc Ricinoleate for Odor and Total Volatile Organic Compounds

Mass produced acrylonitrile-butadiene-styrene copolymer is made as described in Example 1 and has about 12.5 wt % polybutadiene content at in the copolymer, as measured by Fourier Transform infrared spectroscopy, about 23.5 wt % acrylonitrile content in the copolymer, as measured by Fourier Transform infrared spectroscopy, about 3.4 wt % N-phenyl maleimide content in the copolymer, as measured by Fourier Transform infrared spectroscopy, gas an average rubber particle size at 1.0 micron, as determined on a Coulter Multisizer II with the ACCUCOMPTM software ver. 2.01 and has a weight average molecular weight (Mw) at about 146 kg/mole for the matrix copolymer, as measured by gel permeation chromatography (GPC) using narrow molecular weight polystyrene standards, determinations and a refractive index (RI) detector. Zinc ricinoleate is purchased from Evonik, grade name TEGO SORB PY88. The results are shown in the table below.

| | Comp. Example | | | Example | | |
|---|---|---|---|---|---|---|
| Composition | 1 | 2 | 3 | 4 | 5 | 6 |
| MASS ABS wt % | 100 | 99.9 | 99.7 | 99.9 | 99.5 | 99.0 |
| Zinc ricinoleate wt % | | | | 0.1 | 0.5 | 1 |
| Zinc stearate wt % | | 0.1 | 0.3 | | | |
| TVOC by VDA277 | 20.6 | 19.9 | 18.4 | 14.4 | 15.8 | 19.9 |
| (μg/g) | | | | | | |
| Odor rating by VDA270 | 4.0 | 3.5 | 3.5 | 2.5 | 2.0 | 3.0 |

### Example 6

### Testing Procedure VDA-277

Approximately 2 grams of pellet prepared in Example 2 is weighed in a 25 mL headspace vial and is statically equilibrated at 120° C. for 5 hours (using helium as carrier gas), analyses were performed in triplicate. Quantification is based on external calibration via acetone. The method uses a headspace gas chromatography with FID as a detector. Quantification data is obtained via a summation of the areas of all peaks being compared versus the area of toluene external standard.

### Example 7

### Testing Procedure VDA-270

A 1 or 3 liter glass testing cup with unscented sealing and lid; the cup, the sealing and the lid is cleaned before use was employed in the testing procedure. The specimen quantity is specified in three steps as described in table below. The assignment to variants A/B/C is made according to the proportional quantity of material used in the vehicle interior. Variant B, which uses a 20 g pellet sample in a 1-litre-vessel is employed in Example 6. The vessel is closed and stored in the pre-heated thermal chamber.

| | | Quantity for | |
|---|---|---|---|
| Variant | Application | 1-litre-vessel | 3-litre-vessel |
| A | Clips, stoppers, spouts and | (10 ± 1) g )¹ | (30 ± 3) g |
| | other small parts | | |
| B | Arm rests, ash trays, straps, | (20 ± 2) g | (60 ± 6) cm³ |
| | gear shift lever bellows, | | |
| | sun shields and other | | |
| | components of medium | | |
| | size | | |
| C | Covering and insulating | (50 ± 5) cm³ | (150 ± 15) cm³ |
| | materials, films, leather, | respectively | |
| | foamed materials, carpets | | |
| | and other materials with | (200 ± 20) cm² )² | |
| | large surfaces | | |

)¹ when the total amount of the sample (the part) in the vehicle is less than 10 g, then this is the maximum amount used for the test.
)² for large area materials with a thickness < 3 mm

Three storage conditions are available in the table below. Variant 3, i.e. heating the sample at 80° C. for 2 hours is used in Example 4.

| Variant | Temperature | Storage duration |
|---|---|---|
| 1 | (23 ± 2) ° C. | (24 ± 1) h |
| 2 | (40 ± 2) ° C. | (24 ± 1) h |
| 3 | (80 ± 2) ° C. | 2 h ± 10 min |

To begin the odor level evaluation, the test vessel is removed from the thermal chamber and is cooled down to a test temperature of 60° C. prior to the evaluation. Approval tests are made by at least three testers. For odor testing the cover of the test vessel is lifted as little as possible for minimizing the air exchange with the environment. The odor evaluation is made for the variant B, using a grading system from 1 to 6, half-steps being allowed. The odor rating according to the scale described below is indicated as an arithmetic mean of the individual grades, the value being rounded down to half-step grades, with indication of the test method and the variant used.

### Evaluation Scale:

| | |
|---|---|
| Grade 1 | not perceptible |
| Grade 2 | perceptible, not disturbing |
| Grade 3 | clearly perceptible, but not disturbing |
| Grade 4 | disturbing |
| Grade 5 | strongly disturbing |
| Grade 6 | not acceptable |

### Example 8

### Testing of Mass Produced Acrylonitrile-Butadiene-Styrene Copolymer Compounded with Zinc Ricinoleate for Odor and Total Volatile Organic Compounds

Mass produced acrylonitrile-butadiene-styrene copolymer is made as described in Example 1 and has about 12.5 wt % polybutadiene content at in the copolymer, as measured by Fourier Transform infrared spectroscopy, about 23.5 wt % acrylonitrile content in the copolymer, as measured by Fourier Transform infrared spectroscopy, about 3.4 wt % N-phenyl maleimide content in the copolymer, as measured by Fourier Transform infrared spectroscopy, gas an average rubber particle size at 1.0 micron, as determined on a Coulter Multisizer II with the ACCUCOMP™ software ver. 2.01 and has a weight average molecular weight (Mw) at about 146 kg/mole for the matrix copolymer, as measured by gel permeation chromatography (GPC) using narrow molecular weight polystyrene standards, determinations and a refractive index (RI) detector. The results are shown in the table below.

### Example 9

### Testing of ABS Molding Part

The samples were made as described in Example 4. The size of sample plaques is 60 mm×90 mm×2 mm. The samples were sealed in aluminum foil bags in prior of testing. The molding parts were cut into 20 g samples and being tested by VDA-270, variant B. The vessel volume is 1 liter. The results are shown in the table below.

| | Comp. Example | Example | |
|---|---|---|---|
| Composition | 1 | 2 | 3 |
| Odor rating by VDA270 | 3.5 | 3.0 | 3.0 |

1. A styrenic polymer including from about 0.05 wt % to about 2.0 wt % of a zinc salt and a pigment, wherein the zinc salt is a zinc salt of a fatty acid, wherein the amount of volatile organic compounds is less than 30 μg/g and the amount of residual styrene is between 50 ppm and 300 ppm of the composition.

2. The polymer of claim 1, wherein the polymer is general purpose styrene (GPPS), high impact polystyrene (HIPS), styrene-acrylonitrile (SAN), acrylonitrile-butadiene-styrene (ABS) or combinations thereof.

3. The polymer of claim 1, wherein the pigment is present in an amount of 0.1% to 15% by weight of the styrenic polymer composition.

4. The polymer of claim 1, wherein the zinc salt is zinc ricinoleate, zinc stearate, zinc palmitate, zinc laurate, or combinations thereof.

5. The polymer of claim 1, wherein the amount of volatile organic compounds is less than about 20 μg/g.

6. The polymer of claim 1, wherein the pigment is an inorganic pigment.

7. The polymer of claim 1, further comprising one or more of a zeolite, activated carbon, or bamboo charcoal.

8. The polymer of claim 6, wherein the inorganic pigment is comprised of carbon black.

9. The polymer of claim 1, wherein the amount of residual styrene is between about 50 ppm and about 200 ppm.

10. A method of reducing the amount of volatile organic compounds in a styrenic polymer comprising adding from about 0.05 wt % to about 2.0 wt % of a zinc salt to the styrenic polymer, wherein the zinc salt is a zinc salt of a fatty acid and a pigment in an amount by weight of the styrenic polymer from about 0.1% to 15% by weight.

11. A method of preparing the polymer of claim 1 comprising:
mixing pellets of the polymer with a zinc salt;
feeding the mixture into an extruder;
collecting the extrudate; and
making pellets of the extrudate.

12. The method of claim 11, wherein the barrel of the extruder is at between about 210° C. and about 240° C. and the rate of screw rotation is between about 250 rpm and about 350 rpm.

13. A masterbatch comprising:
between about 70 wt % and about 90% wt % of a styrenic polymer;
between about 0 wt % and 15 wt % of a pigment; and
between about 1 wt % and about 15 wt % of a zinc salt, wherein the zinc salt is a zinc salt of a fatty acid.

14. The masterbatch of claim 13, wherein pigment is an inorganic pigment.

15. The masterbatch of claim 13, wherein the zinc salt is zinc ricinoleate, zinc stearate, zinc palmitate, zinc laurate, or combinations thereof.

16. The masterbatch of claim 14, wherein the pigment is comprised of carbon black.

17. The masterbatch of claims 16, wherein the master batch is further comprised of one or more of a zeolite, activated carbon, or bamboo charcoal.

18. The masterbatch of claim 16, further comprising antioxidants, stearate salts, colorants, mold release agents or combinations thereof.

19. A method of making the masterbatch of claim 13 comprising:
mixing pellets of the polymer with a zinc salt and a pigment;
feeding the mixture into an extruder;
collecting the extrudate; and
making pellets of the extrudate.

20. A method of making a styrenic polymer molding part comprising:
premixing between about 1 wt % and about 6 wt % of the masterbatch of claim 13 with between about 94 wt % and 99 wt % of a styrenic polymer; and
feeding the mixture into an injection molding apparatus.
